(19) United States
(12) Patent Application Publication
(10) Pub. No.: US 2026/0330235 A1
(43) Pub. Date: Oct. 22, 2026

(54) CONTRASTIVE LEARNING METHOD BASED ON SELF-SUPERVISED LEARNING USING PROGRESSIVELY INCREASING PARAMETER VALUES AND APPARATUS FOR THE SAME

(71) Applicant: Electronics and Telecommunications Research Institute, Daejeon (KR)

(72) Inventors: Seon-Tae Kim, Daejeon (KR); Joon-Sun Auh, Daejeon (KR); Chang-Sik Cho, Daejeon (KR); Ji-Young Kwak, Gwangju (KR); Hong-Soog Kim, Daejeon (KR); Jae-Bok Park, Daejeon (KR); Jin-Wuk Seok, Daejeon (KR); Ik-Soo Shin, Daejeon (KR); Kyung-Hee Lee, Daejeon (KR); Hyun-Woo Cho, Sejong-si (KR)

(73) Assignee: Electronics and Telecommunications Research Institute, Daejeon (KR)

(21) Appl. No.: 19/269,758

(22) Filed: Jul. 15, 2025

(30) Foreign Application Priority Data
Apr. 17, 2025 (KR) 10-2025-0050190

(51) Int. Cl. G06N 3/0895; G06N 3/048

(52) U.S. Cl. CPC G06N 3/0895; G06N 3/048

(57) ABSTRACT

Disclosed herein are a contrastive learning method based on self-supervised learning using progressively increasing parameter values and a method for the same. The contrastive learning method includes setting an early-stage learning parameter for concentrating distribution of homogenous data for reference data across a feature vector space, setting a late-stage learning parameter for evenly distributing the homogenous data across the feature vector space, and performing contrastive learning on a training model by performing an early-stage learning phase and a late-stage learning phase based on progressive upscaling of a parameter value from the early-stage learning parameter to the late-stage learning parameter.

### CROSS REFERENCE TO RELATED APPLICATION

This application claims the benefit of Korean Patent Application No. 10-2025-0050190, filed Apr. 17, 2025, which is hereby incorporated by reference in its entirety into this application.

### BACKGROUND OF THE INVENTION

### 1. Technical Field

The present disclosure relates to contrastive learning technology based on self-supervised learning using progressively increasing parameter values, and more particularly to contrastive learning technology using progressively increasing parameter values, which performs learning through a process of attracting similar data closer and repelling dissimilar data apart based on self-supervised learning on a large amount of unlabeled data.

### 2. Description of the Related Art

In conventional contrastive learning, when batch input with a certain size is given, only augmented versions of a relevant image, among pieces of given data, are considered to be same-class (homogenous) data, while all images augmented from other images are treated as different-class (heterogeneous) data. In this situation, pieces of homogeneous data are attracted together while pieces of heterogeneous data are repelled, thus enabling a neural network to be trained in accordance with the features of the data, with the result that pieces of data can be distinguished from each other.

In the case where the batch size exceeds the number of classes desired to be classified or where inputs are randomly provided, even if pieces of homogeneous data are input, the pieces of data may be recognized as heterogeneous data to be repelled if they are not identical images. This situation is referred to as a false negative problem, and there is a need to supplement this situation for performance improvement. To solve this problem, classification may be performed by predicting homogeneous data. Here, a cosine inner product between pieces of data may be obtained, and the corresponding data may be classified as homogenous data when the cosine inner product is close to 1.

In addition, there is the issue of determining the appropriate strength with which data is repelled and attracted. In conventional technology, a fixed value was set during learning, and then the learning process was performed.

### PRIOR ART DOCUMENTS

### Patent Documents

(Patent Document 1) Korean Patent Application Publication No. 10-2024-0085181, Date of Publication: Jun. 14, 2024 (Title: Dual Temperature Contrastive Learning Method and Apparatus thereof)

### SUMMARY OF THE INVENTION

Accordingly, the present disclosure has been made keeping in mind the above problems occurring in the prior art, and an object of the present disclosure is to provide higher learning performance by setting parameters for neural network training to values that progressively change in accordance with the progress of learning, rather than fixed values.

Another object of the present disclosure is to improve the accuracy of self-supervised learning based on contrastive learning.

A further object of the present disclosure is to determine learning parameters obtained from research papers or experiments, and increase the accuracy of learning by progressively scaling up the determined learning parameters.

In accordance with an aspect of the present disclosure to accomplish the above objects, there is provided a contrastive learning method performed by a contrastive learning apparatus, including setting an early-stage learning parameter for concentrating distribution of homogenous data for reference data across a feature vector space; setting a late-stage learning parameter for evenly distributing the homogenous data across the feature vector space; and performing contrastive learning on a training model by performing an early-stage learning phase and a late-stage learning phase based on progressive upscaling of a parameter value from the early-stage learning parameter to the late-stage learning parameter.

Each of the early-stage learning parameter and the late-stage learning parameter may include similarity corresponding to a criterion for classifying the homogeneous data and sensitivity corresponding to a strength with which data is repelled and attracted in the feature vector space.

Values of similarity and sensitivity corresponding to the early-stage learning parameter may be set lower than values of similarity and sensitivity corresponding to the late-stage learning parameter.

A higher value of the similarity may mean that the similarity between pieces of data is higher, and a lower value of the sensitivity may mean that the strength with which data is repelled and attracted is greater.

Performing the contrastive learning may include generating pieces of augmented data based on data input in units of a batch size; classifying the homogenous data based on a first similarity corresponding to the early-stage learning parameter, among the pieces of augmented data, and performing the early-stage learning phase by repelling and attracting the classified homogenous data in accordance with a first sensitivity corresponding to the early-stage learning parameter; and classifying the homogenous data based on a second similarity corresponding to the late-stage learning parameter, among the pieces of augmented data, and performing the late-stage learning phase by repelling and attracting the classified homogenous data in accordance with a second sensitivity corresponding to the late-stage learning parameter.

Performing the contrastive learning may further include setting a number of epochs for determining a number of iterative training cycles by adding the early-stage learning phase and the late-stage learning phase; setting a slope of a curve in consideration of the set number of epochs; calculating loss while progressively scaling up the first similarity and the first sensitivity to the second similarity and the second sensitivity based on the number of epochs and the slope of the curve during performance of the early-stage learning phase and the late-stage learning phase; and updating the training model based on the loss.

In accordance with another aspect of the present disclosure to accomplish the above objects, there is provided a contrastive learning apparatus, including a processor configured to set an early-stage learning parameter for concentrating distribution of homogenous data for reference data across a feature vector space, set a late-stage learning parameter for evenly distributing the homogenous data across the feature vector space, and perform contrastive learning on a training model by performing an early-stage learning phase and a late-stage learning phase based on progressive upscaling of a parameter value from the early-stage learning parameter to the late-stage learning parameter; and a memory configured to store the early-stage learning parameter and the late-stage learning parameter.

Each of the early-stage learning parameter and the late-stage learning parameter may include similarity corresponding to a criterion for classifying the homogeneous data and sensitivity corresponding to a strength with which data is repelled and attracted in the feature vector space.

Values of similarity and sensitivity corresponding to the early-stage learning parameter may be set lower than values of similarity and sensitivity corresponding to the late-stage learning parameter.

A higher value of the similarity may mean that the similarity between pieces of data is higher, and a lower value of the sensitivity may mean that the strength with which data is repelled and attracted is greater.

The processor may be configured to generate pieces of augmented data based on data input in units of a batch size, classify the homogenous data based on a first similarity corresponding to the early-stage learning parameter, among the pieces of augmented data, perform the early-stage learning phase by repelling and attracting the classified homogenous data in accordance with a first sensitivity corresponding to the early-stage learning parameter, classify the homogenous data based on a second similarity corresponding to the late-stage learning parameter, among the pieces of augmented data, and perform the late-stage learning phase by repelling and attracting the classified homogenous data in accordance with a second sensitivity corresponding to the late-stage learning parameter.

The processor may be configured to set a number of epochs for determining a number of iterative training cycles by adding the early-stage learning phase and the late-stage learning phase, set a slope of a curve in consideration of the set number of epochs, calculate loss while progressively scaling up the first similarity and the first sensitivity to the second similarity and the second sensitivity based on the number of epochs and the slope of the curve during performance of the early-stage learning phase and the late-stage learning phase, and update the training model based on the loss.

### BRIEF DESCRIPTION OF THE DRAWINGS

The above and other objects, features and advantages of the present disclosure will be more clearly understood from the following detailed description taken in conjunction with the accompanying drawings, in which:

FIG. 1 is an operation flowchart illustrating a contrastive learning method based on self-supervised learning using progressively increasing parameter values according to an embodiment of the present disclosure;

FIG. 2 is a diagram illustrating a relationship between learning parameters θ and τ in contrastive learning;

FIG. 3 is a diagram illustrating the difference between a step function and a sigmoid function;

FIGS. 4 and 5 are diagrams illustrating examples of similarity increase patterns according to the slope values of curves according to the present disclosure;

FIG. 6 is a diagram illustrating an example of a learning performance graph according to the epoch value according to the present disclosure;

FIG. 7 is an operation flowchart illustrating in detail a contrastive learning method based on self-supervised learning using progressively increasing parameter values according to an embodiment of the present disclosure; and

FIG. 8 is a block diagram illustrating a contrastive learning apparatus based on self-supervised learning using progressively increasing parameter values according to an embodiment of the present disclosure.

### DESCRIPTION OF THE PREFERRED EMBODIMENTS

The present disclosure will be described in detail below with reference to the accompanying drawings. Repeated descriptions and descriptions of known functions and configurations which have been deemed to make the gist of the present disclosure unnecessarily obscure will be omitted below. The embodiments of the present disclosure are intended to fully describe the present disclosure to a person having ordinary knowledge in the art to which the present disclosure pertains. Accordingly, the shapes, sizes, etc. of components in the drawings may be exaggerated to make the description clearer.

In the present specification, each of phrases such as “A or B”, “at least one of A and B”, “at least one of A or B”, “A, B, or C”, “at least one of A, B, and C”, and “at least one of A, B, or C” may include any one of the items enumerated together in the corresponding phrase, among the phrases, or all possible combinations thereof.

Hereinafter, embodiments of the present disclosure will be described in detail with reference to the attached drawings.

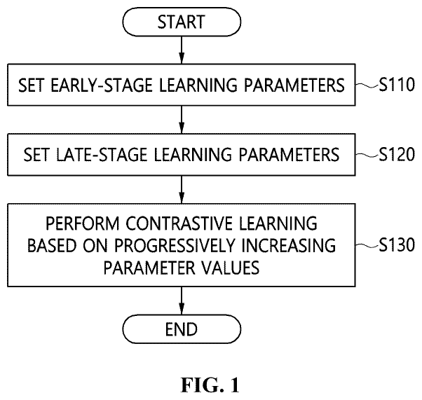

FIG. 1 is an operation flowchart illustrating a contrastive learning method based on self-supervised learning using progressively increasing parameter values according to an embodiment of the present disclosure.

Referring to FIG. 1, in the contrastive learning method based on self-supervised learning using progressively increasing parameter values according to the embodiment of the present disclosure, a contrastive learning apparatus sets early-stage learning parameters for concentrating the distribution of homogenous data (i.e., positive samples) for reference data across a feature vector space at step S110.

Further, in the contrastive learning method based on self-supervised learning using progressively increasing parameter values according to the embodiment of the present disclosure, the contrastive learning apparatus sets late-stage learning parameters to evenly distribute the homogeneous data across the feature vector space at step S120.

Here, each of the early-stage learning parameters and the late-stage learning parameters may include similarity corresponding to a criterion for classifying homogeneous data and sensitivity corresponding to the strength with which data is repelled and attracted in the feature vector space.

Here, the values of similarity and sensitivity corresponding to the early-stage learning parameters may be set lower than the values of similarity and sensitivity corresponding to the late-stage learning parameters.

Here, the similarity may mean that, as the value thereof is higher, the similarity between pieces of data is higher, and the sensitivity may mean that, as the value thereof is lower, the strength with which data is repelled or attracted is greater.

Generally, in contrastive learning, a loss value may be calculated by placing homogeneous data in the numerator of the equation and by placing heterogeneous data (i.e., negative samples) in the denominator of the equation, as shown in Equation (1).

$$l = - {\sum }_{i ∈ I} \frac{1}{P ( i )} {\sum }_{i ∈ P ( i )} Iog \frac{exp ( cosim ( {𝓏}_{i} , {𝓏}_{j} ) / τ )}{2 ( N - 1 ) {\sum }_{k \neq j} exp ( cosim ( {𝓏}_{i} , {𝓏}_{j} ) / τ )} \qquad ( 1 )$$

Here, cosim(zᵢ, zⱼ) denotes an inner product of two vectors zᵢ and zⱼ, and it can be seen that, as the value of the inner product is closer to 1, the similarity is determined to be higher, and as the value of the inner product is closer to −1, the similarity is lower, and then the difference between feature vectors is larger. In existing contrastive learning, loss was obtained by classifying only data augmented from the same instance as homogenous data, that is, similar data (positive samples) in an environment in which those similarity values are not used. This scheme increased the likelihood of false negative samples. Therefore, in the present disclosure, a certain threshold may be placed for similarity values. It may be assumed that, when the similarity of specific modified data exceeds the certain threshold, the modified data is similar data, and Equation (1) may be applied.

Here, in Equation (1), τ may represent the sensitivity indicating how strongly to attract or repel other data based on anchor data, which is reference data, when homogenous data and heterogeneous data are distinguished based on the similarity between two pieces of data.

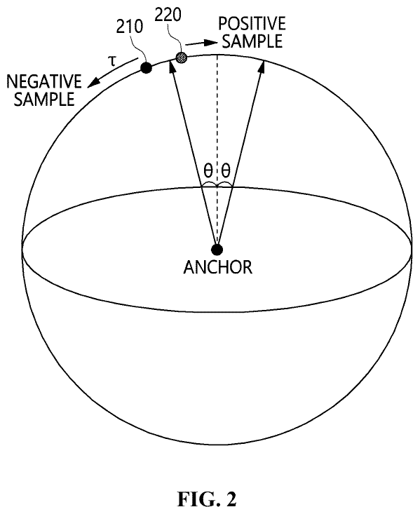

For example, referring to FIG. 2, data 210 may represent the case where the sensitivity τ is low, resulting in strong repulsion, and data 220 may represent the case where the sensitivity τ is high, resulting in weak attraction.

Further, in contrastive learning, it has been demonstrated through research that classification accuracy is improved only when feature vectors are evenly distributed on the surface of a unit hypersphere, such as that illustrated in FIG. 2. Therefore, in the present disclosure, learning parameters are variably set using these properties.

First, because the early-stage learning phase corresponds to the level of initial learning, learning may be performed based on the early-stage learning parameters corresponding to low similarity and extreme sensitivity. In other words, when a large number of pieces of augmented data are classified as homogeneous data due to a low similarity value, the extreme sensitivity increases the strength of attraction or repulsion, thus obtaining the effect of gathering homogeneous data together on the surface of the unit hypersphere, as illustrated in FIG. 2.

However, in the early-stage learning phase, an area on which data distribution data is concentrated and an area in which data distribution is empty occur in the feature vector space corresponding to the surface of the unit hypersphere due to an extreme sensitivity value. Therefore, in order to evenly distribute feature vectors on the surface of the unit hypersphere, only data having similarity higher than that in the early-stage learning phase is classified as homogenous data in a late-stage learning phase, and the effect of evenly distributing pieces of homogenous data on the surface of the unit hypersphere may be obtained by decreasing sensitivity.

For example, when optimal values for similarity and sensitivity are calculated based on actual experiments, the (similarity, sensitivity) corresponding to the early-stage learning parameters may be set to (0.93, 0.2), while the (similarity, sensitivity) corresponding to the late-stage learning parameters may be set to (0.99, 0.5).

Further, in the contrastive learning method based on self-supervised learning using progressively increasing parameter values according to the embodiment of the present disclosure, the contrastive learning apparatus performs contrastive learning on a training model by performing an early-stage learning phase and a late-stage learning phase based on progressively increasing parameter values from the early-stage learning parameters to the late-stage learning parameters at step S130.

Here, pieces of augmented data may be generated based on data that is input in units of a batch size.

Here, among the pieces of augmented data, the homogenous data (positive samples) may be classified based on first similarity corresponding to the early-stage learning parameter, and the classified homogenous data may perform the early-stage learning phase by repelling and attracting the classified homogenous data in accordance with first sensitivity corresponding to the early-stage learning parameter.

For example, in the early-stage learning phase, the similarity between the pieces of augmented data and the anchor data may be calculated, and augmented data having a similarity equal to or greater than the first similarity may be classified as homogeneous data (positive samples). The positive samples classified in this way may be repelled and attracted depending on the first sensitivity, and may then be distributed on the surface of the unit hypersphere corresponding to the feature vector space. Here, because the first sensitivity is set to an extreme value, the positive samples may be gathered and arranged on the surface of the unit hypersphere.

Here, among the pieces of augmented data, the homogenous data (positive samples) may be classified based on second similarity corresponding to the late-stage learning parameter, and the late-stage learning phase may be performed on the classified positive samples by repelling and attracting the classified positive samples in accordance with second sensitivity corresponding to the late-stage learning parameter.

For example, in the late-stage learning phase, the similarity between the pieces of augmented data and the anchor data may be calculated, and pieces of augmented data having a similarity equal to or greater than the second similarity may be classified as homogeneous data (positive samples). The positive samples classified in this way may be repelled and attracted depending on the second sensitivity, and may then be distributed on the surface of the unit hypersphere corresponding to the feature vector space. Here, since the second sensitivity is set lower than the first sensitivity, the positive samples may be evenly distributed on the surface of the unit hypersphere.

Here, the number of epochs, which determines the number of iterative training cycles by adding the early-stage learning phase and the late-stage learning phase, may be set, and the slope of a curve may be set in consideration of the set number of epochs.

Loss may be calculated while progressively scaling up the first similarity and the first sensitivity to the second similarity and the second sensitivity based on the number of epochs and the slope of the curve during the performance of the early-stage learning phase and the late-stage learning phase, and the training model may be updated based on the loss.

For example, the present disclosure may calculate similarity corresponding to a similarity threshold and the sensitivity t using a sigmoid function, as represented by the following Equation (2):

f(x)=a+b*sigmoid((x−α/2)/β) (2)

Here, ‘a’ may correspond to a similarity or sensitivity value corresponding to the early-stage learning parameter, and ‘b’ may correspond to a value obtained by subtracting the similarity or sensitivity value corresponding to the early-stage learning parameter from the similarity or sensitivity value corresponding to the late-stage learning parameter. In addition, α may denote the number of learning epochs, and β may refer to the slope of the curve. Therefore, learning may be performed while the similarity and the sensitivity are progressively increasing with the increase in the number of learning epochs. That is, learning may be performed by substituting the similarity and the sensitivity, calculated through Equation (2), into the above-described Equation (1).

For example, assuming that the (similarity, sensitivity) corresponding to the early-stage learning parameters are (0.93, 0.2), the (similarity, sensitivity) corresponding to the late-stage learning parameters are (0.99, 0.5), and the number of learning epochs is 200, progressive value changes may be calculated, as shown in the following Equations (3) to (5):

Similarity f(x)=0.93+0.06*sigmoid((x−100)/1) (3)

Similarity f(x)=0.93+0.06*((sgn(x−100)+1)/2) (4)

Sensitivity f(x)=0.2+0.3*sigmoid((x−100)/1) (5)

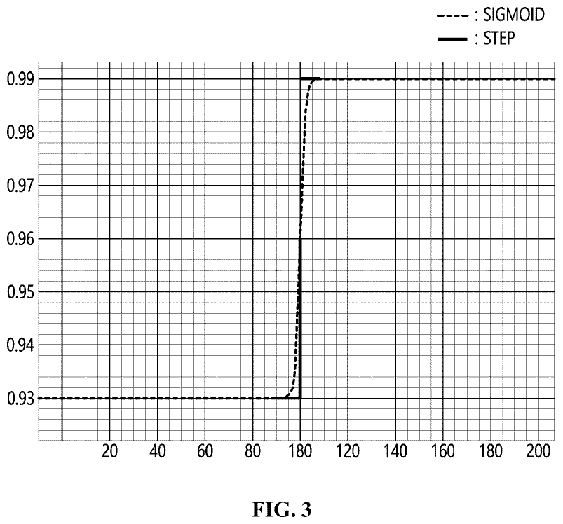

Here, Equation (3) uses a sigmoid function, Equation (4) uses a step function, and FIG. 3 illustrates a graph of an increase pattern indicating a comparison between the functions. Here, referring to the graph illustrated in FIG. 3, it can be seen that, as the sensitivity value is lower, the curve becomes closer to the step function.

In another example, when the slope of the curve is set to 25 in the setting identical to Equation (3), the progressive value change such as that of Equation (6) may be calculated.

Similarity f(x)=0.93+0.06*sigmoid((x−100)/25) (6)

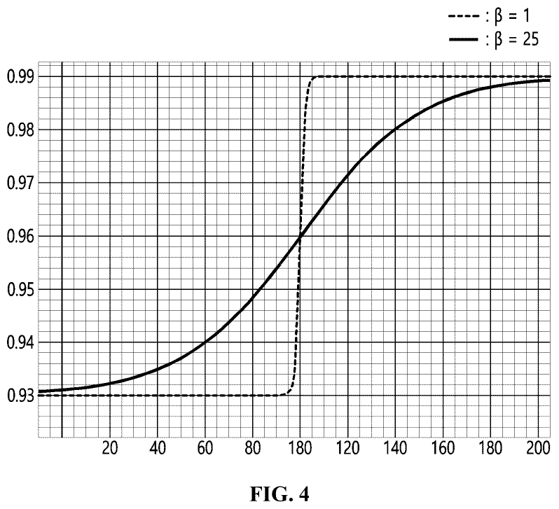

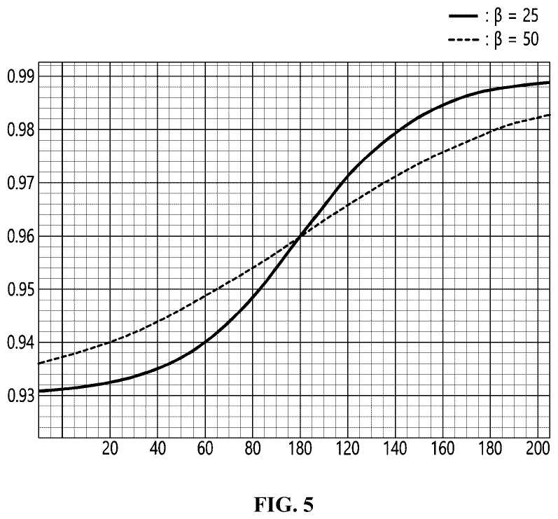

Here, FIGS. 4 and 5 illustrate similarity increase patterns according to the β value, which is the slope of the curve.

First, referring to FIG. 4, it can be seen that, in the case where the β value is set to 25, the curve has a gentle slope unlike the case where the β value is set to 1. Therefore, a pattern in which similarity uniformly increases is formed in a range corresponding to an early-stage learning parameter and a start learning parameter over 200 epochs. In this case, it was experimentally observed that the performance of contrastive learning was improved.

Here, the equation related to sensitivity may be applied, as shown in Equation (7).

Sensitivity f(x)=0.2+0.3*sigmoid((x−100)/25) (7)

Further, referring to FIG. 5, the case where the β value is set to 25 and the case where the β value is set to 50 are illustrated together. It can be seen that, in the case where the β value is 50, learning is initiated or terminated without completely using parameters in the early-stage learning phase and the late-stage learning phase. Therefore, the β value needs to be determined by the α value which determines the number of times iterative training is performed. That is, a relational expression between β and α may be represented by the following Equation (8).

β=λ*α (8)

Here, λ may denote a proportional constant.

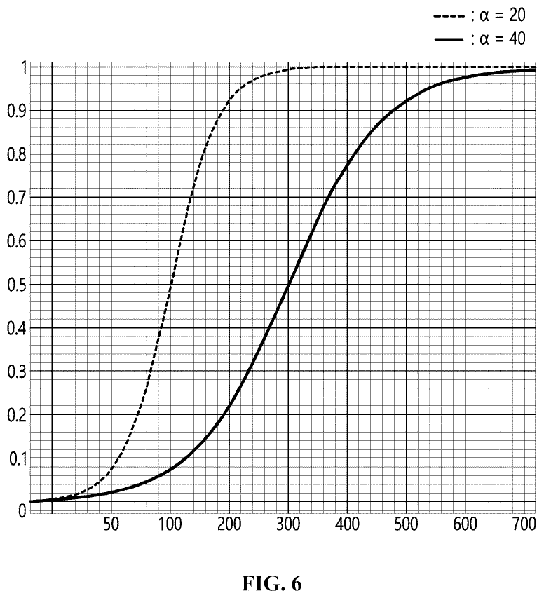

FIG. 6 is a diagram illustrating an example of a learning performance graph according to the epoch value according to the present disclosure, wherein learning performance graphs for 200 epochs and 400 epochs are depicted.

Here, a sigmoid function presented in the present disclosure may be regarded as one example, and a method using other activation functions (e.g., ReLU, Leaky ReLU, Tanh, GeLU, Swish, or the like) used in existing neural networks may also be applied.

Through such a contrastive learning method, higher learning performance may be provided by setting parameters for neural network training to values that progressively change in accordance with the progress of training, rather than fixed values.

Further, the accuracy of self-supervised learning based on contrastive learning may be improved.

Furthermore, learning parameters obtained by research papers or experiments may be determined, and the accuracy of learning may be increased by progressively scaling up the determined learning parameters.

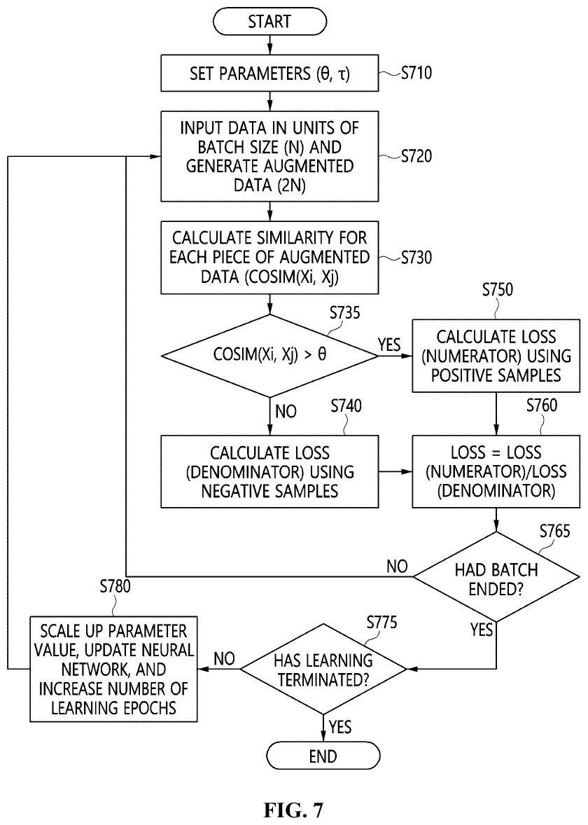

FIG. 7 is an operation flowchart illustrating in detail a contrastive learning method based on self-supervised learning using progressively increasing parameter values according to an embodiment of the present disclosure.

Referring to FIG. 7, the contrastive learning method based on self-supervised learning using progressively increasing parameter values according to the embodiment of the present disclosure first sets early-stage learning parameters (θ, τ) and late-stage learning parameters (θ, τ), respectively, at step S710. When data is input in units of a batch size (N), the contrastive learning method may generate augmented data with a size 2N at step S720.

Thereafter, similarity COSIM(Xi, Xj) for each piece of augmented data based on the set learning parameters may be calculated at step S730.

Thereafter, whether the similarity calculated for the augmented data exceeds the similarity corresponding to the set learning parameters may be determined at step S735.

When it is determined at step S735 that the similarity calculated for the augmented data does not exceed the similarity corresponding to the set learning parameters, it may be determined that the corresponding augmented data is heterogeneous data (i.e., negative samples), the augmented data values are placed in the denominator of Equation (1) at step S740, and loss may be calculated at step S760.

Further, when it is determined at step S735 that the similarity calculated for the augmented data exceeds the similarity corresponding to the set learning parameters, it may be determined that the corresponding augmented data is homogeneous data (i.e., positive samples), the augmented data values are placed in the numerator of Equation (1) at step S750, and loss may be calculated at step S760.

Thereafter, whether the batch has ended is determined at step S765. When it is determined that the batch has not ended, the process from step S720 may be repeatedly performed.

On the other hand, it may be determined at step S765 that the batch has ended, whether iterative training based on a set number of learning epochs is terminated may be determined at step S775.

When it is determined at step S775 that iterative training is not terminated, learning parameters (θ, τ) corresponding to similarity and sensitivity may be scaled up (increased) through progressive upscaling-based calculation, the neural network may be updated, and then the number of learning epochs may increase at step S780. Thereafter, the process from step S720 may be repeatedly performed.

On the other hand, when it is determined at step S775 that iterative training based on the set number of learning epochs is terminated, the training process may be terminated.

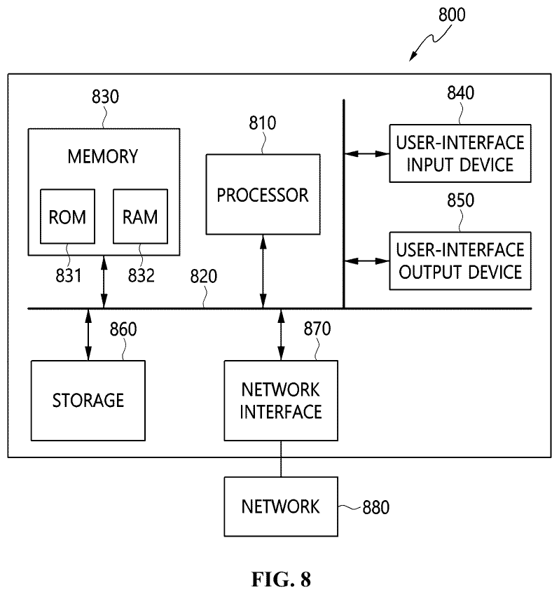

FIG. 8 is a diagram illustrating a contrastive learning apparatus according to an embodiment of the present disclosure.

Referring to FIG. 8, the contrastive learning apparatus according to the embodiment of the present disclosure may be implemented in a computer system such as a computer-readable storage medium. As illustrated in FIG. 8, a computer system 800 may include one or more processors 810, memory 830, a user interface input device 840, a user interface output device 850, and a storage 860, which communicate with each other through a bus 820. The computer system 800 may further include a network interface 870 connected to a network 880. Each processor 810 may be a Central Processing Unit (CPU) or a semiconductor device for executing programs or processing instructions stored in the memory 830 or the storage 860. Each of the memory 830 and the storage 860 may be any of various types of volatile or nonvolatile storage media. For example, the memory 830 may include Read-Only Memory (ROM) 831 or Random Access Memory (RAM) 832.

Therefore, the embodiment of the present disclosure may be implemented as a non-transitory computer-readable medium in which a computer-implemented method or computer-executable instructions are stored. When the computer-readable instructions are executed by the processor, the computer-readable instructions may perform the method according to at least one aspect of the present disclosure.

The processor 810 sets early-stage learning parameters for concentrating the distribution of homogenous data (positive samples) for reference data across a feature vector space.

Also, the processor 810 sets late-stage learning parameters for evenly distributing the positive samples across the feature vector space.

Here, each of the early-stage learning parameters and the late-stage learning parameters may include similarity corresponding to a criterion for classifying homogeneous data and sensitivity corresponding to the strength with which data is repelled and attracted in the feature vector space.

Here, the values of similarity and sensitivity corresponding to the early-stage learning parameters may be set lower than the values of similarity and sensitivity corresponding to the late-stage learning parameters.

Here, the similarity may mean that, as the value thereof is higher, the similarity between pieces of data is higher, and the sensitivity may mean that, as the value thereof is lower, the strength with which data is repelled or attracted is greater.

Further, the processor 810 performs contrastive learning on a training model by performing an early-stage learning phase and a late-stage learning phase based on progressively increasing parameter values from the early-stage learning parameters to the late-stage learning parameters.

Here, pieces of augmented data may be generated based on data that is input in units of a batch size.

Here, among the pieces of augmented data, the homogenous data (positive samples) may be classified based on first similarity corresponding to the early-stage learning parameter, and the classified homogenous data may perform the early-stage learning phase by repelling and attracting the classified homogenous data in accordance with first sensitivity corresponding to the early-stage learning parameter.

Here, among the pieces of augmented data, the homogenous data (positive samples) may be classified based on second similarity corresponding to the late-stage learning parameter, and the late-stage learning phase may be performed on the classified positive samples by repelling and attracting the classified positive samples in accordance with second sensitivity corresponding to the late-stage learning parameter.

Here, the number of epochs, which determines the number of iterative training cycles by adding the early-stage learning phase and the late-stage learning phase, may be set, and the slope of a curve may be set in consideration of the set number of epochs.

Loss may be calculated while progressively scaling up the first similarity and the first sensitivity to the second similarity and the second sensitivity based on the number of epochs and the slope of the curve during the performance of the early-stage learning phase and the late-stage learning phase, and the training model may be updated based on the loss.

The memory 830 stores the early-stage learning parameters and the late-stage learning parameters.

Also, the memory 830 stores various types of information occurring in the contrastive learning apparatus based on self-supervised learning using progressively increasing parameter values according to the embodiment of the present disclosure, as described above.

According to an embodiment, the memory 830 may be configured independently of the contrastive learning apparatus to support functions for contrastive learning based on self-supervised learning using progressively increasing parameter values. Here, the memory 830 may function as separate mass storage, and may include a control function for performing operations.

Meanwhile, the contrastive learning apparatus may be equipped with memory to store information within the apparatus. In an embodiment, the memory may be a computer-readable medium. In an embodiment, the memory may be a volatile memory unit, and in another embodiment, the memory may be a nonvolatile memory unit. In an embodiment, a storage device may be a computer-readable medium. In various different embodiments, the storage device may be, for example, a hard disk device, an optical disk device, or another type of mass storage device.

By utilizing the contrastive learning apparatus, higher learning performance may be provided by setting parameters for neural network training to values that progressively change in accordance with the progress of training, rather than fixed values.

Further, the accuracy of self-supervised learning based on contrastive learning may be improved.

Furthermore, learning parameters obtained by research papers or experiments may be determined, and the accuracy of learning may be increased by progressively scaling up the determined learning parameters.

According to the present disclosure, higher learning performance may be provided by setting parameters for neural network training to values that progressively change in accordance with the progress of learning, rather than fixed values.

Further, the present disclosure may improve the accuracy of self-supervised learning based on contrastive learning.

Furthermore, the present disclosure may determine learning parameters obtained from research papers or experiments, and increase the accuracy of learning by progressively scaling up the determined learning parameters.

As described above, in the contrastive learning method based on self-supervised learning using progressively increasing parameter values and the apparatus for the contrastive learning method according to the present disclosure, the configurations and schemes in the above-described embodiments are not limitedly applied, and some or all of the above embodiments can be selectively combined and configured such that various modifications are possible.

What is claimed is:

1. A contrastive learning method performed by a contrastive learning apparatus, comprising:
setting an early-stage learning parameter for concentrating distribution of homogenous data for reference data across a feature vector space;
setting a late-stage learning parameter for evenly distributing the homogenous data across the feature vector space; and
performing contrastive learning on a training model by performing an early-stage learning phase and a late-stage learning phase based on progressive upscaling of a parameter value from the early-stage learning parameter to the late-stage learning parameter.

2. The contrastive learning method of claim 1, wherein each of the early-stage learning parameter and the late-stage learning parameter includes similarity corresponding to a criterion for classifying the homogeneous data and sensitivity corresponding to a strength with which data is repelled and attracted in the feature vector space.

3. The contrastive learning method of claim 2, wherein values of similarity and sensitivity corresponding to the early-stage learning parameter are set lower than values of similarity and sensitivity corresponding to the late-stage learning parameter.

4. The contrastive learning method of claim 3, wherein a higher value of the similarity means that the similarity between pieces of data is higher, and a lower value of the sensitivity means that the strength with which data is repelled and attracted is greater.

5. The contrastive learning method of claim 2, wherein performing the contrastive learning comprises:
generating pieces of augmented data based on data input in units of a batch size;
classifying the homogenous data based on a first similarity corresponding to the early-stage learning parameter, among the pieces of augmented data, and performing the early-stage learning phase by repelling and attracting the classified homogenous data in accordance with a first sensitivity corresponding to the early-stage learning parameter; and
classifying the homogenous data based on a second similarity corresponding to the late-stage learning parameter, among the pieces of augmented data, and performing the late-stage learning phase by repelling and attracting the classified homogenous data in accordance with a second sensitivity corresponding to the late-stage learning parameter.

6. The contrastive learning method of claim 5, wherein performing the contrastive learning further comprises:
setting a number of epochs for determining a number of iterative training cycles by adding the early-stage learning phase and the late-stage learning phase;
setting a slope of a curve in consideration of the set number of epochs;
calculating loss while progressively scaling up the first similarity and the first sensitivity to the second similarity and the second sensitivity based on the number of epochs and the slope of the curve during performance of the early-stage learning phase and the late-stage learning phase; and
updating the training model based on the loss.

7. A contrastive learning apparatus, comprising:
a processor configured to set an early-stage learning parameter for concentrating distribution of homogenous data for reference data across a feature vector space, set a late-stage learning parameter for evenly distributing the homogenous data across the feature vector space, and perform contrastive learning on a training model by performing an early-stage learning phase and a late-stage learning phase based on progressive upscaling of a parameter value from the early-stage learning parameter to the late-stage learning parameter; and
a memory configured to store the early-stage learning parameter and the late-stage learning parameter.

8. The contrastive learning apparatus of claim 7, wherein each of the early-stage learning parameter and the late-stage learning parameter includes similarity corresponding to a criterion for classifying the homogeneous data and sensitivity corresponding to a strength with which data is repelled and attracted in the feature vector space.

9. The contrastive learning apparatus of claim 8, wherein values of similarity and sensitivity corresponding to the early-stage learning parameter are set lower than values of similarity and sensitivity corresponding to the late-stage learning parameter.

10. The contrastive learning apparatus of claim 9, wherein a higher value of the similarity means that the similarity between pieces of data is higher, and a lower value of the sensitivity means that the strength with which data is repelled and attracted is greater.

11. The contrastive learning apparatus of claim 8, wherein the processor is configured to generate pieces of augmented data based on data input in units of a batch size, classify the homogenous data based on a first similarity corresponding to the early-stage learning parameter, among the pieces of augmented data, perform the early-stage learning phase by repelling and attracting the classified homogenous data in accordance with a first sensitivity corresponding to the early-stage learning parameter, classify the homogenous data based on a second similarity corresponding to the late-stage learning parameter, among the pieces of augmented data, and perform the late-stage learning phase by repelling and attracting the classified homogenous data in accordance with a second sensitivity corresponding to the late-stage learning parameter.

12. The contrastive learning apparatus of claim 11, wherein the processor is configured to set a number of epochs for determining a number of iterative training cycles by adding the early-stage learning phase and the late-stage learning phase, set a slope of a curve in consideration of the set number of epochs, calculate loss while progressively scaling up the first similarity and the first sensitivity to the second similarity and the second sensitivity based on the number of epochs and the slope of the curve during performance of the early-stage learning phase and the late-stage learning phase, and update the training model based on the loss.
